(19) United States
(12) Patent Application Publication
(10) Pub. No.: US 2026/0136259 A1
(43) Pub. Date: May 14, 2026

(54) COMMUNICATION METHOD AND COMMUNICATION APPARATUS

(71) Applicant: Huawei Technologies Co., Ltd., Shenzhen (CN)

(72) Inventors: Hao Tang, Ottawa (CA); Yiqun Ge, Ottawa (CA); Jianglei Ma, Ottawa (CA)

(21) Appl. No.: 19/407,829

(22) Filed: Dec. 3, 2025

Related U.S. Application Data
(63) Continuation of application No. PCT/CN2023/124999, filed on Oct. 17, 2023.
(60) Provisional application No. 63/507,790, filed on Jun. 13, 2023.

(51) Int. Cl. H04W 36/30; H04W 36/00

(52) U.S. Cl. CPC H04W 36/30; H04W 36/0058

(57) ABSTRACT

Embodiments of the present application provide a communication method and a communication apparatus. The method includes: sending a report indicating switching of an artificial intelligence (AI) model or switching of a mode when an entry condition or a leaving condition of an event is fulfilled. The method provided in the present application defines multiple events and entry and leaving conditions corresponding to the events, which enable active model or mode switching when the conditions are fulfilled.

### CROSS-REFERENCE TO RELATED APPLICATIONS

This application is a continuation of International Application No. PCT/CN2023/124999, filed on Oct. 17, 2023, which claims priority to U.S. Provisional Patent Application No. 63/507,790, filed on Jun. 13, 2023.

The disclosures of the aforementioned applications are hereby incorporated by reference in their entirety.

### TECHNICAL FIELD

Embodiments of the present application relate to the field of communication, and more specifically, to a communication method and a communication apparatus.

### BACKGROUND

AI-based algorithms have been introduced into modern wireless communications to solve some wireless problems such as channel estimation, scheduling, channel state information (CSI) compression (from a user equipment to a base-station), multiple-input multiple-output (MIMO)'s beamforming, positioning and so on. As data-driven methods, AI-based algorithms inevitably suffer from low generalization. Performance of artificial intelligence (AI) models are only as good as the data they are trained on. Even if the AI model is trained on a large number of data sets, it may also not possess the necessary knowledge to perform effectively in other environments, especially in wireless communication where the channel information is changed rapidly.

Due to generalization issues, a user equipment (UE) or a base station (BS) needs to detect its generalization performance and then switch to the proper AI models. For example, there are multiple AI models for multiple scenarios, including indoor urban, outdoor urban, and rural areas, high speed train, etc. When the surrounding environment is changed, the BS or the UE needs to switch to another model. In prior art when the inference performance is getting worse, the UE or the BS switches its AI model or falls back to a non-AI mode. It is a kind of reactive solution.

Therefore, how to perform AI model switching in advance is an urgent technical problem to be solved.

### SUMMARY

Embodiments of the present application provide a communication method and a communication apparatus. In the technical solutions of the present application, multiple events, as well as entry and leaving conditions corresponding to the events, are defined such that when any one of the conditions is fulfilled, active model or mode switching can be realized.

According to a first aspect, an embodiment of the present application provides a communication method including: sending a report indicating switching of an artificial intelligence (AI) model or switching of a mode when an entry condition or a leaving condition of an event is fulfilled.

The method provided in the present application defines multiple events and entry and leaving conditions corresponding to the events, which enable active model or mode switching when the conditions are fulfilled.

The event can be any of the following: an operation of switching from an AI model to a non-AI model, an operation of switching from a first AI model to a second AI model, an operation of switching from a non-AI model to an AI model, an operation of switching from a third AI model to a fourth AI model. Among them, the third AI model can be the same as the second AI model and the fourth AI model can be the same as the first AI model.

In a possible implementation, the event is an operation of switching from an AI mode to a non-AI mode, where the entry condition is determined by Diff11 and Thresh11, or the leaving condition is determined by Diff11 and Thresh12, where Diff11 is a first difference value, Thresh11 is a first threshold, Thresh12 is a second threshold, the first difference value is a difference value between first data and a first anchor, the first anchor includes one or multiple pieces of reference data, and the first threshold and the second threshold are pre-defined or configured thresholds corresponding to the event.

The first data includes monitoring data or measured data of a user equipment or a network device. Further, the first data is the monitoring data or measured data related to the AI models. The first data can include any one or more of sensing data, measured data, channel data, neuron data of an AI model, and latent output data of the AI model. The network device can be a BS.

The first anchor can be indicated by a BS, e.g., the first anchor is the data anchor of the current AI/machine learning (ML) model. Alternatively, the first anchor is the closest data anchor to the first data, i.e., the first anchor is the data anchor among the multiple anchors that differs least from the first data.

The event related to the operation of switching from an AI mode to a non-AI mode can be referred to as an event K1. The event K1 means the current or the best AI/ML model may be out of date, and the UE or the BS should be switched to the non-AI mode.

The method provided by the present application defines an event K1 and entry and leaving conditions corresponding to the event K1, and active switching of modes can be realized when any of the conditions is fulfilled.

In a possible implementation, the entry condition is Diff11− Hys11>Thresh11, or the leaving condition is Diff11+Hys12<Thresh12.

Hys11 is a first hysteresis parameter, Hys12 is a second hysteresis parameter, and the first hysteresis parameter and the second hysteresis parameter are pre-defined or configured parameters corresponding to the event K1.

The units of Thresh11, Thresh12, Hys11 and Hys12 are the same as the unit of Diff11.

Hys11 and Hys12 can be the same or different, e.g. they can be similar. Thresh11 and thresh12 can be the same or different, e.g. they can be similar.

In a possible implementation, the entry condition is Diff11+offset11−Hys11>Thresh11, or the leaving condition is Diff11+offset12+Hys12<Thresh12, where offset11 and offset12 are pre-defined or configured offsets.

The offset 11 and offset 12 can be the same or different. The values of offset11 and offset12 could be positive or negative numbers.

The method provided by the present application defines an event K1 and entry and leaving conditions corresponding to the event K1, and active switching of modes can be realized when any of the conditions is fulfilled.

In a possible implementation, the event is an operation of switching from a first AI model to a second AI model, where the entry condition is determined by Diff21, Diff22, Thresh21 and Thresh22, or the leaving condition is determined by Diff21, Diff22, Thresh23 and Thresh24, where Diff21 is a second difference value, Diff22 is a third difference value, Thresh21 is a third threshold, Thresh22 is a fourth threshold, Thresh23 is a fifth threshold, Thresh24 is a sixth threshold, the second difference value is a difference value between first data and a second anchor, the second anchor is a data anchor associated with the first AI model, the third difference value is a difference value between the first data and a third anchor, the third anchor is a data anchor associated with the second AI model, the third threshold and the fifth threshold are pre-defined or configured thresholds corresponding to the first AI model, and the fourth threshold and the sixth threshold are pre-defined or configured thresholds corresponding to the second AI model.

The event related to the operation of switching from a first AI model to a second AI model can be referred to as an event K2. The event K2 means that the current AI/ML model (called as model 1) may be out of date, and the UE should be switched to another model (model 2).

In the event K2, the current model becomes worse than a Thresh21, and another model becomes better than a Thresh22. Being worse than the Thresh21 means that the second difference value between the first data and the second anchor is greater than the Thresh21. Being better than the Thresh22 means that a third difference value between the first data and the third anchor is smaller than the Thresh22. Thresh21 and Thresh22 can be configured to be the same or different.

The method provided by the present application defines an event K2 and entry and leaving conditions corresponding to the event K2, and active switching of models can be realized when any of the conditions is fulfilled.

In a possible implementation, the entry condition is Diff21−Hys21>Thresh21 and Diff22+Hys22<Thresh22, or the leaving condition is Diff21+Hys23<Thresh23 or Diff22−Hys24>Thresh24.

Hys21 is a third hysteresis parameter, Hys22 is a fourth hysteresis parameter, Hys23 is a fifth hysteresis parameter, Hys24 is a sixth hysteresis parameter, and the third hysteresis parameter, the fourth hysteresis parameter, the fifth hysteresis parameter and the sixth hysteresis parameter are pre-defined or configured parameters corresponding to the event K2.

Hys21 and Hys23 can be the same or different, e.g. they can be similar. Hys22 and Hys24 can be the same or different, e.g. they can be similar. Thresh21 and Thresh23 can be the same or different, e.g. they can be similar. Thresh22 and Thresh24 can be the same or different, e.g. they can be similar.

In a possible implementation, the entry condition is Diff21+offset21−Hys21>Thresh21 and Diff22+offset22+Hys22<Thresh22, and the leaving condition is Diff21+offset23+Hys23<Thresh23 or Diff22+offset24−Hys24>Thresh24, where offset21, offset22, offset23 and offset24 are pre-defined or configured offsets.

The offset 21 and the offset 23 can be the same or different, e.g. they can be similar. The offset 22 and the offset 24 can be the same or different, e.g. they can be similar. The values of offset21, offset 22, offset 23, and offset24 could be positive or negative numbers.

The method provided by the present application defines an event K2 and entry and leaving conditions corresponding to the event K2, and active switching of models can be realized when any of the conditions is fulfilled.

In a possible implementation, the event is an operation of switching from a non-AI mode to an AI mode, where the entry condition is determined by Diff31 and Thresh31, or the leaving condition is determined by Diff31 and Thresh32, where Diff31 is a fourth difference value, Thresh31 is a seventh threshold, Thresh32 is an eighth threshold, the fourth difference value is a difference value between first data and a fourth anchor, the fourth anchor includes one or multiple pieces of reference data, and the seventh threshold and the eighth threshold are pre-defined or configured thresholds corresponding to the event.

The event related to the operation of switching from a non-AI mode to an AI mode can be referred to as an event K3. The event K3 means that an AI/ML model becomes better than a threshold, and the UE or the BS should be switched from the non-AI mode to the AI mode.

In the event K3, the fourth difference value between the first data and the fourth anchor is smaller than a threshold. The fourth anchor can be indicated by the BS, or the fourth anchor is the closest data anchor to the first data, i.e., the fourth anchor is the data anchor among the multiple anchors that differs least from the first data.

The method provided by the present application defines an event K3 and entry and leaving conditions corresponding to the event K3, and active switching of modes can be realized when any of the conditions is fulfilled.

In a possible implementation, the entry condition is Diff31+Hys31<Thresh31, or the leaving condition is Diff31−Hys32>Thresh32.

Hys31 is a seventh hysteresis parameter, Hys32 is an eighth hysteresis parameter, and the seventh hysteresis parameter and the eighth hysteresis parameter are pre-defined or configured parameters corresponding to the event K3.

The units of Thresh31, Thresh32, Hys31 and Hys32 are the same as the unit of Diff31.

Hys31 and Hys32 can be the same or different, e.g. they can be similar. Thresh31 and thresh32 can be the same or different, e.g. they can be similar.

In a possible implementation, the entry condition is Diff31+offset31+Hys31<Thresh31, and the leaving condition is Diff31+offset32−Hys32>Thresh32, where offset31 and offset32 are pre-defined or configured offsets.

The offset 31 and the offset 32 can be the same or different. The values of offset31 and offset32 could be positive or negative numbers.

The method provided by the present application defines an event K3 and entry and leaving conditions corresponding to the event K3, and active switching of modes can be realized when any of the conditions is fulfilled.

In a possible implementation, the event is an operation of switching from a third AI model to a fourth AI model, where the entry condition is determined by Diff41 and Diff42, or the leaving condition is determined by Diff41 and Diff42, Diff41 is a fifth difference value, Diff42 is a sixth difference value, the fifth difference value is a difference value between first data and a fifth anchor, the fifth anchor is a data anchor associated with the third AI model, the sixth difference value is a difference value between the first data and a sixth anchor, and the sixth anchor is a data anchor associated with the fourth AI model.

The event related to the operation of switching from a third AI model to a fourth AI model can be referred to as an event K4. In the event K4, another model (model 2) is better than the current model (model 1) and the UE or the BS should switch to model 2.

The method provided by the present application defines an event K4 and entry and leaving conditions corresponding to the event K4, and active switching of models can be realized when any of the conditions is fulfilled.

In a possible implementation, the entry condition is Diff42+Hys41<Diff41, and the leaving condition is Diff42−Hys42>Diff41.

Hys41 is a ninth hysteresis parameter, Hys42 is a tenth hysteresis parameter, and the ninth hysteresis parameter and the tenth hysteresis parameter are pre-defined or configured parameters corresponding to the event K4.

Hys41 and Hys42 can be the same or different, e.g. they can be similar.

In a possible implementation, the entry condition is Diff42+offset42+Hys41<Diff41+offset41, and the leaving condition is Diff42+offset42−Hys42>Diff41+offset41, where offset41 and offset42 are pre-defined or configured offsets.

The offset 41 and the offset 42 can be the same or different. The values of offset41 and offset42 could be positive or negative numbers.

The method provided by the present application defines an event K4 and entry and leaving conditions corresponding to the event K4, and active switching of models can be realized when any of the conditions is fulfilled.

In a possible implementation, the first data includes monitoring data or measured data of a user equipment or a network device.

In a possible implementation, the first data includes monitoring data or measured data related to an AI model of the user equipment or the network device.

In a possible implementation, the first data includes any one or more of sensing data, measured data, channel data, neuron data of an AI model, and latent output data of the AI model.

In a possible implementation, the method further includes: performing communication based on the report.

In a possible implementation, the method is executed by a user equipment or a network device.

According to a second aspect, this application provides a communication apparatus, including: a sending module configured to send a report indicating switching of an artificial intelligence (AI) model or switching of a mode when an entry condition or a leaving condition of an event is fulfilled.

In a possible implementation, the event is an operation of switching from an AI mode to a non-AI mode, where the entry condition is determined by Diff11 and Thresh11, or the leaving condition is determined by Diff11 and Thresh12, where Diff11 is a first difference value, Thresh11 is a first threshold, Thresh12 is a second threshold, the first difference value is a difference value between first data and a first anchor, the first anchor includes one or multiple pieces of reference data, and the first threshold and the second threshold are pre-defined or configured thresholds corresponding to the event.

In a possible implementation, the entry condition is Diff11− Hys1>Thresh11, or the leaving condition is Diff1+Hys12<Thresh12.

In a possible implementation, the entry condition is Diff1+offset11−Hys11>Thresh11, or the leaving condition is Diff1+offset12+Hys12<Thresh12, where offset11 and offset12 are pre-defined or configured offsets.

In a possible implementation, Hys11 is a first hysteresis parameter, Hys12 is a second hysteresis parameter, and the first hysteresis parameter and the second hysteresis parameter are pre-defined or configured parameters corresponding to the event.

In a possible implementation, the event is an operation of switching from a first AI model to a second AI model, where the entry condition is determined by Diff21, Diff22, Thresh21 and Thresh22, or the leaving condition is determined by Diff21, Diff22, Thresh23 and Thresh24, where Diff21 is a second difference value, Diff22 is a third difference value, Thresh21 is a third threshold, Thresh22 is a fourth threshold, Thresh23 is a fifth threshold, Thresh24 is a sixth threshold, the second difference value is a difference value between first data and a second anchor, the second anchor is a data anchor associated with the first AI model, the third difference value is a difference value between the first data and a third anchor, the third anchor is a data anchor associated with the second AI model, the third threshold and the fifth threshold are pre-defined or configured thresholds corresponding to the first AI model, and the fourth threshold and the sixth threshold are pre-defined or configured thresholds corresponding to the second AI model.

In a possible implementation, the entry condition is Diff21−Hys21>Thresh21 and Diff22+Hys22<Thresh22, or the leaving condition is Diff21+Hys23<Thresh23 or Diff22−Hys24>Thresh24.

In a possible implementation, the entry condition is Diff21+offset21−Hys21>Thresh21 and Diff22+offset22+Hys22<Thresh22, and the leaving condition is Diff21+offset23+Hys23<Thresh23 or Diff22+offset24−Hys24>Thresh24, where offset21, offset22, offset23 and offset24 are pre-defined or configured offsets.

In a possible implementation, Hys21 is a third hysteresis parameter, Hys22 is a fourth hysteresis parameter, Hys23 is a fifth hysteresis parameter, Hys24 is a sixth hysteresis parameter, and the third hysteresis parameter, the fourth hysteresis parameter, the fifth hysteresis parameter and the sixth hysteresis parameter are pre-defined or configured parameters corresponding to the event.

In a possible implementation, the event is an operation of switching from a non-AI mode to an AI mode, where the entry condition is determined by Diff31 and Thresh31, or the leaving condition is determined by Diff31 and Thresh32, where Diff31 is a fourth difference value, Thresh31 is a seventh threshold, Thresh32 is an eighth threshold, the fourth difference value is a difference value between first data and a fourth anchor, the fourth anchor includes one or multiple pieces of reference data, and the seventh threshold and the eighth threshold are pre-defined or configured thresholds corresponding to the event.

In a possible implementation, the entry condition is Diff31+Hys31<Thresh31, or the leaving condition is Diff31−Hys32>Thresh32.

In a possible implementation, the entry condition is Diff31+offset31+Hys31<Thresh31, and the leaving condition is Diff31+offset32−Hys32>Thresh32, where offset31 and offset32 are pre-defined or configured offsets.

In a possible implementation, Hys31 is a seventh hysteresis parameter, Hys32 is an eighth hysteresis parameter, and the seventh hysteresis parameter and the eighth hysteresis parameter are pre-defined or configured parameters corresponding to the event.

In a possible implementation, the event is an operation of switching from a third AI model to a fourth AI model, where the entry condition is determined by Diff41 and Diff42, or the leaving condition is determined by Diff41 and Diff42, Diff41 is a fifth difference value, Diff42 is a sixth difference value, the fifth difference value is a difference value between first data and a fifth anchor, the fifth anchor is a data anchor associated with the third AI model, the sixth difference value is a difference value between the first data and a sixth anchor, and the sixth anchor is a data anchor associated with the fourth AI model.

In a possible implementation, the entry condition is Diff42+Hys41<Diff41, and the leaving condition is Diff42−Hys42>Diff41.

In a possible implementation, the entry condition is Diff42+offset42+Hys41<Diff41+offset41, and the leaving condition is Diff42+offset42−Hys42>Diff41+offset41, where offset41 and offset42 are pre-defined or configured offsets.

In a possible implementation, Hys41 is a ninth hysteresis parameter, Hys42 is a tenth hysteresis parameter, and the ninth hysteresis parameter and the tenth hysteresis parameter are pre-defined or configured parameters corresponding to the event.

In a possible implementation, the first data includes monitoring data or measured data of a user equipment or a network device.

In a possible implementation, the first data includes monitoring data or measured data related to an AI model of the user equipment or the network device.

In a possible implementation, the first data includes any one or more of sensing data, measured data, channel data, neuron data of an AI model, and latent output data of the AI model.

In a possible implementation, the apparatus further includes a processing module configured to perform communication based on the report.

In a possible implementation, the apparatus is located on a user equipment or a network device.

According to a third aspect, a communication apparatus including a processor and a memory is provided. The processor is connected to the memory. The memory is configured to store instructions, and the processor is configured to execute the instructions. When the processor executes the instructions stored in the memory, the processor is enabled to perform the method in any possible implementation of the first aspect.

According to a fourth aspect, this application provides a computer readable storage medium, which includes instructions. When the instructions run on a processor, the processor is enabled to perform the method in any possible implementation of the first aspect.

According to a fifth aspect, this application provides a computer program product, which includes computer program code. When the computer program code runs on a computer, the computer is enabled to perform the method in any possible implementation of the first aspect.

It should be noted that all or a part of the above computer program code can be stored on a first storage medium. The first storage medium can be packaged together with the processor or separately with the processor.

According to a sixth aspect, this application provides a chip system, which includes a memory and a processor. The memory is configured to store a computer program, and the processor is configured to invoke the computer program from the memory and run the computer program, so that an electronic device on which the chip system is disposed performs the method in any possible implementation of the first aspect.

### DESCRIPTION OF DRAWINGS

FIG. 1 is a schematic diagram of a communication system 100 according to an embodiment of the present application.

FIG. 2 is a schematic diagram of a communication system 100 according to an embodiment of the present application.

FIG. 3 is a schematic diagram of an electronic device (ED) 110 and a base station 170a, 170b and/or 170c according to an embodiment of the present application.

FIG. 4 is a schematic diagram of units or modules in a device according to an embodiment of the present application.

FIG. 5 is a schematic diagram of an AI-based communication device.

FIG. 6 is a schematic diagram of a device 500 receiving reference data samples from a device 600 according to an embodiment of the present application.

FIG. 7 is a schematic diagram of reference data samples consisting of a plurality of groups according to an embodiment of the present application.

FIG. 8 is a schematic representation of a DNN-based approximation according to an embodiment of the present application.

FIG. 9 is a flowchart of an embodiment of a communication method according to an embodiment of the present application.

FIG. 10 is a flowchart of an embodiment of a communication method according to an embodiment of the present application.

FIG. 11 is a schematic diagram of projecting a high-dimensional signal to a low-dimensional signal according to an embodiment of the present application.

FIG. 12 is a flowchart of a communication method according to an embodiment of the present application.

FIG. 13 is a schematic diagram of a matrix U determined according to an embodiment of the present application.

FIG. 14 is a schematic diagram of a first sampling matrix P₁ according to an embodiment of the present application.

FIG. 15 is a schematic diagram of a sampling matrix compression matrix U according to an embodiment of the present application.

FIG. 16 is a schematic diagram of a scoring distance on the low spectrum space according to an embodiment of the present application.

FIG. 17 is a flowchart of a communication method according to an embodiment of the present application.

FIG. 18 is a schematic block diagram of a communication apparatus according to an embodiment of the present application.

FIG. 19 is a schematic block diagram of another communication apparatus according to an embodiment of the present application.

### DESCRIPTION OF EMBODIMENTS

The following describes the technical solutions in the present application with reference to the accompanying drawings.

The following describes the technical solutions in the present application with reference to the accompanying drawings. Obviously, the described embodiments are part of the embodiments of the present application, and not all of them. Based on the embodiments in the present application, all other embodiments obtained by a person of ordinary skill in the art without making creative labor shall fall within the scope of protection of the present application.

The present application will present aspects, embodiments, or features around systems that include multiple devices, components, modules, etc. It should be understood and appreciated that the individual systems may include additional devices, components, modules, etc., and/or may not include all of the devices, components, modules, etc., discussed in connection with the accompanying drawings. In addition, combinations of these options may be used.

In addition, in the embodiments of the present application, the word “exemplarily” and the phrase “as an example” are used to indicate, for example, illustration or description. Any embodiment or design solution described as “exemplarily” in this application should not be construed as being superior to or more advantageous than other embodiments or design solutions. Rather, the use of the word “example” is intended to present the concept in a specific manner.

The phrases “in some possible embodiments”, “in some possible application scenarios”, etc., appearing in various places in this description, do not necessarily refer to the same embodiments, but rather mean “one or more, but not all, embodiments” unless otherwise specifically emphasized. Unless otherwise specifically emphasized, the terms “including”, “comprising”, “having”, and variations thereof all mean “including but not limited to”.

In the present application, “at least one” refers to one or more, and “multiple” refers to two or more. “and/or”, describing the association of the associated objects, indicates that three relationships can exist. For example, A and/or B can mean A alone, both A and B, and B alone, where A and B can be singular or plural. The character “/” generally indicates that the preceding and following associated objects are in an “or” relationship.

The application scenarios described in the embodiments of the present application are intended to illustrate the technical solutions of the embodiments of the present application more clearly and do not constitute a limitation to the technical solutions provided by the embodiments of the present application. It is known to those of ordinary skill in the art that the technical solutions provided by the embodiments of the present application are equally applicable to similar technical problems as the system architecture evolves and new application scenarios emerge.

The technical solutions in embodiments of this application may be applied to various communications systems, such as a Global System for Mobile Communications (GSM), a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunications System (UMTS), a Worldwide Interoperability for Microwave Access (WiMAX) communications system, a wireless local area network (WLAN), a fifth generation (5G) wireless communications system, a new ratio (NR) wireless communications system, a sixth generation (6G) wireless communications system, or other evolving communications systems.

In order to better describe the solutions of embodiments in the present application, concepts and terms that may be involved in the present application will be described below.

### (1) Data Collection

Data is a very important component for artificial intelligence (AI)/machine learning (ML) techniques. Data collection is a process of collecting data by the network nodes, management entity, or UE for the purpose of AI/ML model training, data analytics and inference.

### (2) AI/ML Model Training

AI/ML model training is a process to train an AI/ML model by learning the input/output relationship in a data driven manner and obtain the trained AI/ML Model for inference.

### (3) AI/ML Model Inference

A process of using a trained AI/ML model to produce a set of outputs based on a set of inputs.

### (4) AI/ML Model Validation

As a sub-process of training, validation is used to evaluate the quality of an AI/ML model using a dataset different from the one used for model training. Validation can help select model parameters that generalize beyond the dataset used for model training. The model parameter after training can be adjusted further by the validation process.

### (5) AI/ML Model Testing

Similar to validation, testing is also a sub-process of training, and it is used to evaluate the performance of a final AI/ML model using a dataset different from the one used for model training and validation. Different from AI/ML model validation, testing does not assume subsequent tuning of the model.

### (6) Online Training

Online training means an AI/ML training process where the model being used for inference is typically continuously trained in (near) real-time with the arrival of new training samples.

### (7) Offline Training

Offline training is an AI/ML training process where the model is trained based on the collected dataset, and where the trained model is later used or delivered for inference.

### (8) AI/ML Model Delivery/Transfer

AI/ML model delivery/transfer is a generic term referring to the delivery of an AI/ML model from one entity to another entity in any manner. Delivery of an AI/ML model over the air interface includes either parameters of a model structure known at the receiving end or a new model with parameters. Delivery may contain a full model or a partial model.

### (9) Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in the NR air-interface. Life cycle management covers the whole procedure of AI/ML technologies applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery, and UE capability report. Model monitoring can be based on inference accuracy, including metrics related to intermediate key performance indicators (KPIs), and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to environmental changes, and thus the model based on input or output data distribution should also be considered.

### (10) Supervised Learning

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data. Supervised learning can be further divided into two types: Classification and Regression. Classification is used when the output of the AI/ML model is categorical i.e., with two or more classes. Regression is used when the output of the AI/ML model is a real or continuous value.

### (11) Unsupervised Learning

In contrast to supervised learning where the AI/ML models learn to map the input to the target output, the unsupervised methods learn concise representations of the input data without the labelled data, which can be used for data exploration or to analyze or generate new data. One typical unsupervised learning is clustering which explores the hidden structure of input data and provides the classification results for the data.

### (12) Reinforcement Learning

Reinforcement learning is used to solve sequential decision-making problems. Reinforcement learning is a process of training the action of an intelligent agent from input (state) and a feedback signal (reward) in an environment. In reinforcement learning, an intelligent agent interacts with an environment by taking an action to maximize the cumulative reward. Whenever the intelligent agent takes one action, the current state in the environment may transfer to the new state, and the new state resulting from the action will bring the associated reward. Then the intelligent agent can take the next action based on the received reward and new state in the environment. During the training phase, the agent interacts with the environment to collect experience. The environments are often mimicked by the simulator since it is expensive to directly interact with the real system. In the inference phase, the agent can use the optimal decision-making rule learned from the training phase to achieve the maximal accumulated reward.

### (13) Federated Learning

Federated learning (FL) is a machine learning technique that is used to train an AI/ML model by a central node (e.g., server) and a plurality of decentralized edge nodes (e.g., UEs, next Generation NodeBs, “gNBs”). According to the wireless FL technique, a server may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model. Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure is performed multiple iterations until the global AI/ML model is considered to be finalized, e.g., the AI/ML model is converged or the training stopping conditions are satisfied. Notably, the wireless FL technique does not involve the exchange of local data samples. Indeed, the local data samples remain at respective edge nodes.

AI-based algorithms have been introduced into modern wireless communications to solve some wireless problems such as channel estimation, scheduling, channel state information (CSI) compression (from user equipment to base station), Multiple-Input Multiple-Output (MIMO)'s beamforming, positioning, and so on. AI algorithm is a data-driven method that tunes some predefined architectures by a set of data samples called as training data set. The recent AI trains DNN (including CNN, RNN, transformer, etc.) architecture by setting the neurons with a SGD algorithm.

AI techniques (including ML techniques) in communication include AI-based communications in the physical layer and/or AI-based communications in the MAC layer. For the physical layer, the AI communication may aim to optimize component design and/or improve algorithm performance. For the MAC layer, the AI/ML based communication may aim to utilize the AI/ML capability for learning, prediction, and/or making a decision to solve a complicated optimization problem with possible better strategy and/or optimal solution, e.g. to optimize the functionality in the MAC layer, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI architecture may involve multiple nodes, where the multiple nodes may be organized in one of two modes, i.e., centralized and distributed, both of which may be deployed in an access network, a core network, or an edge computing system, or a third party network. A centralized training and computing architecture is restricted by possibly large communication overhead and strict user data privacy. A distributed training and computing architecture may include several frameworks, e.g., distributed machine learning and federated learning. In some embodiments, an AI architecture may include an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

It is now quite common for neural network models to become larger and deeper, which may easily require more computational resources than just one or two computers. Most neural network models would be trained on a powerful computation cloud. A user with a desired neural network architecture, raw training data set, and training goal may not have sufficient local computation resources to train their model locally. In order to access a powerful computation cloud, the user would have to transmit all the specifications of its neural network architecture, its training data set, and its training goal to the network cloud completely. It is mandated that the user must trust the cloud and grant the cloud full authorization to manipulate its intellectual property (neural network architecture, training data set, and training goal).

As data-driven method, AI-based algorithms inevitably suffer from low generalization: if a testing data sample were an outlier to the training data set, a neural network wouldn't make a good inference on the test data sample. Even if the AI model is trained on a large number of data sets, it may also not possess the necessary knowledge to perform effectively in other environments, especially in wireless communication where the channel information is changed rapidly.

In the present application, the AI model is exemplified by a DNN, i.e., a deep neural network or network. The specific AI model should not be construed as a limitation of the present application.

FIG. 1 is a schematic diagram of a communication system according to an embodiment of the present application.

Referring to FIG. 1, as an illustrative example without limitation, a simplified schematic illustration of a communication system is provided. The communication system 100 includes a radio access network 120. The radio access network 120 may be a next generation (e.g. sixth generation (6G) or later) radio access network, or a legacy (e.g. 5G, 4G, 3G or 2G) radio access network. One or more communication electric devices (EDs) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

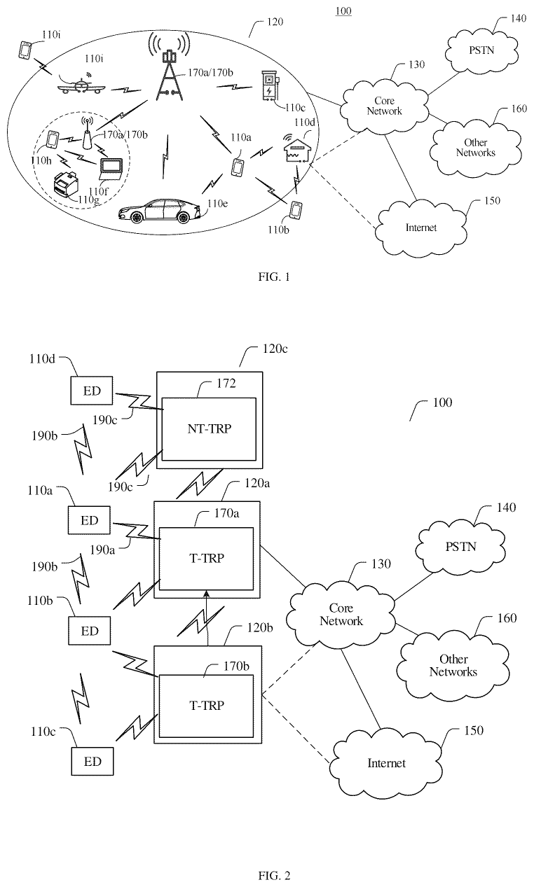

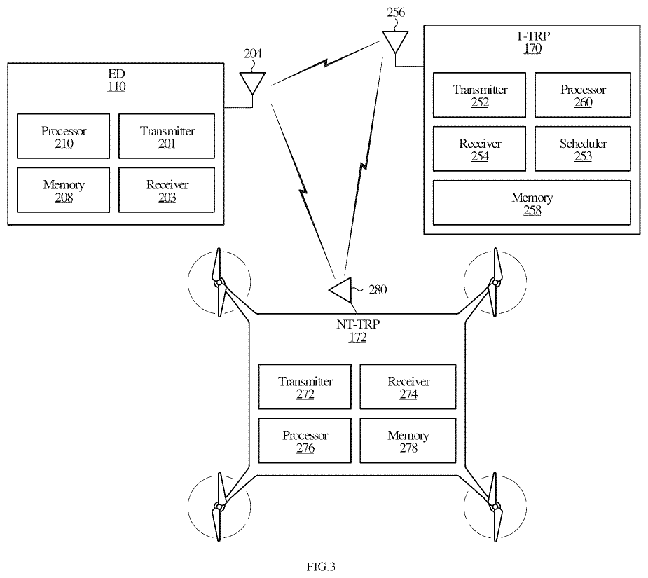

FIG. 2 is a schematic diagram of a communication system 100 according to an embodiment of the present application.

FIG. 2 illustrates an example communication system 100. In general, the communication system 100 enables multiple wireless or wired elements to communicate data and other content. The purpose of the communication system 100 maybe to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system can be regarded as sub-systems of the communication system. In the example shown, the communication system 100 includes electronic devices (EDs) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions. The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 15o, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP), and user datagram protocol (UDP). EDs 110a 110b, and 110c may be multimode devices capable of operation according to multiple radio access technologies, and incorporate multiple transceivers necessary to support such.

FIG. 3 is a schematic diagram of an ED 110 and a base station 170a, 170b and/or 170c according to an embodiment of the present application.

FIG. 3 illustrates another example of an ED 110 and a base station 170a, 170b and/or 170c. The ED 110 is used to connect persons, objects, machines, etc. The ED 110 maybe widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or maybe referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned on (i.e., established, activated, or enabled), turned off (i.e., released, deactivated, or disabled) and/or configured in response to one or more of connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 can store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 maybe implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay nodes, donor nodes, or the like, or combinations thereof. The T-TRP 170 may refer to the forging devices or apparatus (e.g. communication module, modem, or chip) in the foregoing devices.

In some embodiments, the parts of the T-TRP 170 may be distributed. For example, some of the modules of the T-TRP 170 maybe located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which maybe scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling maybe transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 can store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 maybe implemented using dedicated circuitry, such as a FPGA, a GPU, or an ASIC.

Although the NT-TRP 172 is illustrated as a drone only as an example, the NT-TRP 172 maybe implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 maybe integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

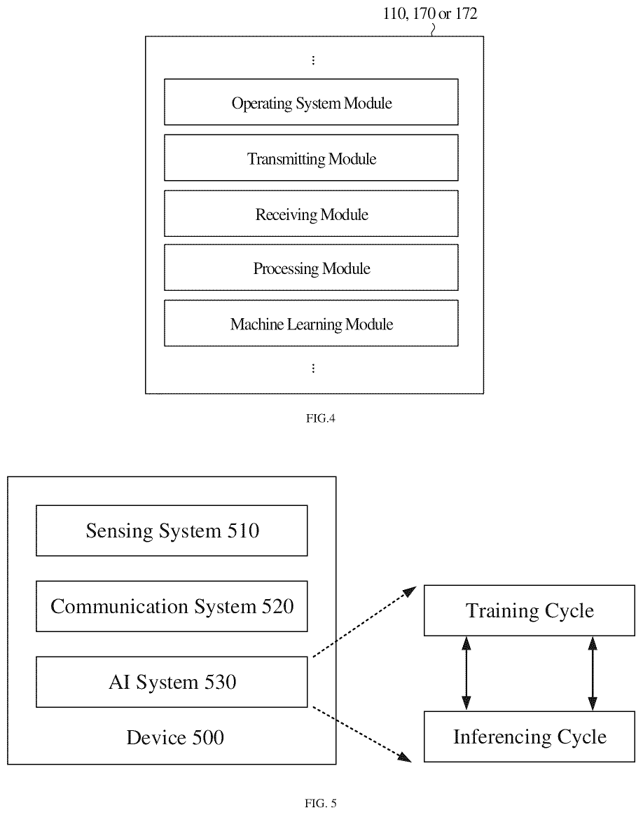

FIG. 4 is a schematic diagram of units or modules in a device according to an embodiment of the present application.

One or more steps of the embodiment methods provided may be performed by corresponding units or modules, according to FIG. 4. FIG. 4 illustrates units or modules in a device, such as in ED 110, T-TRP 170, or NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules maybe implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

FIG. 5 is a schematic diagram of an AI-based communication device.

A wireless system includes a plurality of connected devices. A device 500 is either base station (BS) or user equipment (UE). The device 500 may have three systems: sensing system 510, communication system 520, and/or AI system 530. The sensing system 510 senses and collects signals and data, the communication system 520 transmits and receives signals and data, and the AI system 530 trains and infers the AI implementations. An exemplary AI implementation is based on two cycles of deep learning, a training cycle and an inference cycle. In some possible application scenarios, the training cycle can also be referred to as the learning cycle and the inference cycle can also be referred to as the reasoning cycle.

Deep learning consists of two cycles: training (or learning) and inference (or reasoning). In a training cycle, the coefficients of neurons are learned from training data to fulfill a specific training goal or target. In the inference or reasoning cycle, an input data sample is fed into a trained neural network that would output a prediction.

During a training cycle, the AI system 530 of the device 500 may train the DNN or DNNs where the sensing system 510 of the device 500 may generate signals and/or data. The communication system 520 of the device 500 may receive the signals or data from another device or other devices. During and/or after the AI system 530 finishes training, the communication of the device may transmit the training results to another device or other devices.

During an inference cycle, the AI system 530 of a device 500 may perform one inference or a series of inferences with one DNN or DNNs to fulfill one task or tasks, where the sensing system 510 of the device 500 may generate signals and/or data, the communication system 520 of the device 500 may receive signals or data from another device or other devices. After the AI system 530 of the device 500 finishes inferencing, the communication system 520 of the device 500 may transmit the inferencing results to another device or other devices.

The AI implementations may either switch between the two cycles or stay in the two cycles simultaneously. For example, the AI system 530 of the device 500 may train the second DNN but still performs inference on the first DNN.

During the training cycle, the AI system 530 of the device 500 can work in single-user mode. In this mode, the AI system 530 trains the DNN or DNN(s) with the data provided by the sensing system 510 of the device 500. Examples of the data include local sensing data and local channel data. Local sensing data includes RGB data, light detection and ranging (LiDAR) data, temperature data, air pressure data, electric outrage data, etc. Local channel data includes channel state information (CSI), received signal strength indicator (RSSI), latency data, etc.

Alternatively, the AI system 530 of the device 500 may work in a cooperative mode. In this mode, the AI system 530 trains the DNN or DNN(s) with the data that the communication system 520 of the device 500 receives. Example data includes sensing data, channel data, neuron data and latent output data. Sensing data includes RGB data, LiDAR data, temperature data, air pressure data, electric outrage data, etc. Channel data includes CSI, RSSI, delay data, etc. Neuron data includes a number of neurons or a number of gradients. Latent output data includes several latent outputs.

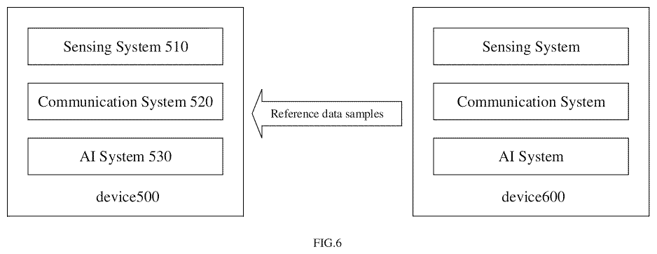

FIG. 6 is a schematic diagram of a device 500 receiving reference data samples from a device 600 according to an embodiment of the present application. The AI system 530 of the device 500 in cooperative mode may use data such as: accumulating the sensing data that the communication system 520 of the device 500 received into one training data set; accumulating the channel data that the communication system 520 of the device 500 received into one training data set; setting local neurons by the neurons that the communication system 520 of the device 500 received, which is a typical federated learning scheme; inputting the latent outputs that the communication system 520 of the device 500 received to its DNN(s).

Alternatively, the AI system 530 of the device 500 in a cooperative mode may use the data that the communication system 520 of the device 500 received together with its local ones, such as: mixing the local sensing data that the sensing system 510 of the device 500 provided with the sensing data that the communication system 520 of the device 500 received into one training data set; mixing the local channel data that the sensing system 510 of the device 500 provided with the channel data that the communication system 520 of the device 500 received into one training data set; averaging the local neurons that the AI system 530 of the device 500 possessed with the neurons that the communication system 520 of the device 500 received, which is a typical federated learning scheme; averaging the local latent outputs that the AI system 530 of the device 500 possessed and inputting them to its DNN(s).

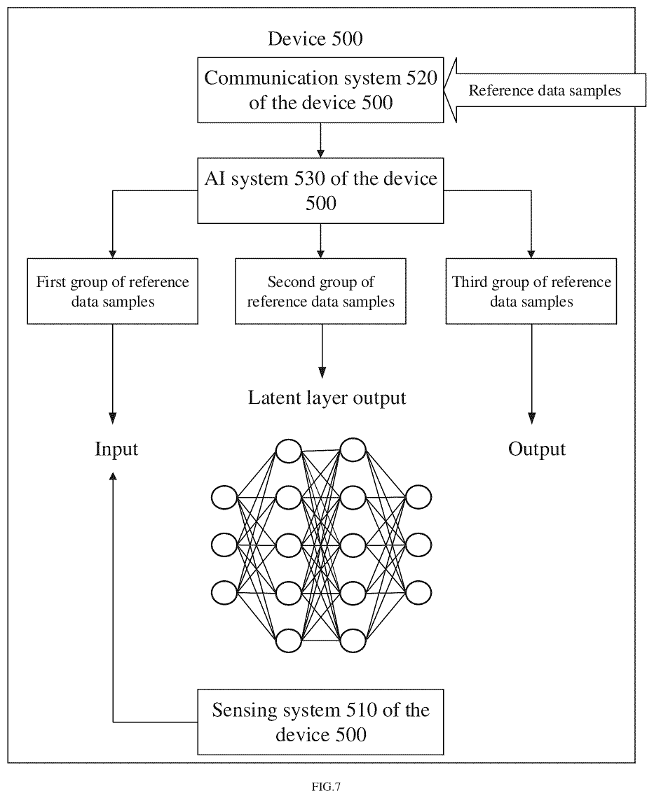

FIG. 7 is a schematic diagram of reference data samples consisting of a plurality of groups according to an embodiment of the present application. During the training cycle, the communication system 520 of the device 500 may receive some reference data samples in both single-user or cooperative mode. Some devices transmit the reference data samples in broadcast, multicast, or unicast channels. The other devices transmits an indicator or indicators about which layer or layers to which the reference data samples are related, where, for example, there are three groups of the reference data samples: the first group of the reference data samples is indicated to be related to the input layer to the DNN, the second group of the reference data samples is indicated to be related to one latent layer output of the DNN, and the third group of the reference data samples is indicated to be related to the layer output from the DNN.

The AI system 530 of the device 500 may measure the distances between its local data samples and reference data samples group by group. The AI system 530 of the device 500 may randomly, non-randomly, uniformly, or non-uniformly sample its local layer inputs, local latent layer outputs, and/or layer outputs. Then the AI system 530 of the device 500 measures the distance between the local samples and the reference samples that the communication system 520 of the device 500 received. If the average distances of all the groups are consistently below a predefined threshold or thresholds, the AI system 530 of the device 500 may tell that the current training procedure works as expected, otherwise the AI system 530 may tell it is abnormal.

In a case where a device has no AI system but has sensing and communication systems, the sensing system of the device may be still able to measure the distances between its local data sample(s) and the reference data sample(s) related to the layer input to the DNN. If the average distance on the layer input is below a predefined threshold, the sensing system of the device may consider that the sensing device is catching “good” data, otherwise bad data. The communication system of the device may transmit only good data to other devices and may not transmit bad data to other devices, or the communication system of the device may label the sensing data with the distance before transmitting them to other devices.

The UE can report information about its data to the BS, which then determines whether that data differs significantly from the training data. If the difference is too large, the BS can switch the operating mode from AI to non-AI mode, or to another AI model. However, UE's direct reporting of raw data may be considered an invasion of user privacy. It is inefficient or against privacy policy to transmit raw data cross the air. Therefore, how to transmit data state information securely and efficiently is an urgent technical problem to be solved.

To protect raw data and save bandwidth, a group of the reference data samples are encoded or compressed to a lower dimensional space than their original space. The encoder or compressor can be linear or non-linear. A linear encoder can be realized with some standard basis such as Fourier Basis, DCT, wavelets, or a linear encoder can be with some customized basis. These bases may consist of a unitary matrix (orthonormal). A non-linear encoder can be realized with some DNNs. FIG. 8 is a schematic representation of a DNN-based approximation according to an embodiment of the present application.

Unlike the traditional compression schemes built for reliable reconstruction, the encoder deliberately avoids a reliable reconstruction but preserves as much topological distances as possible, when the data is compressed into a lower dimensional space. That is, the relative distance between two data samples in their original signal space may be well preserved after being encoded into a low-dimensional space.

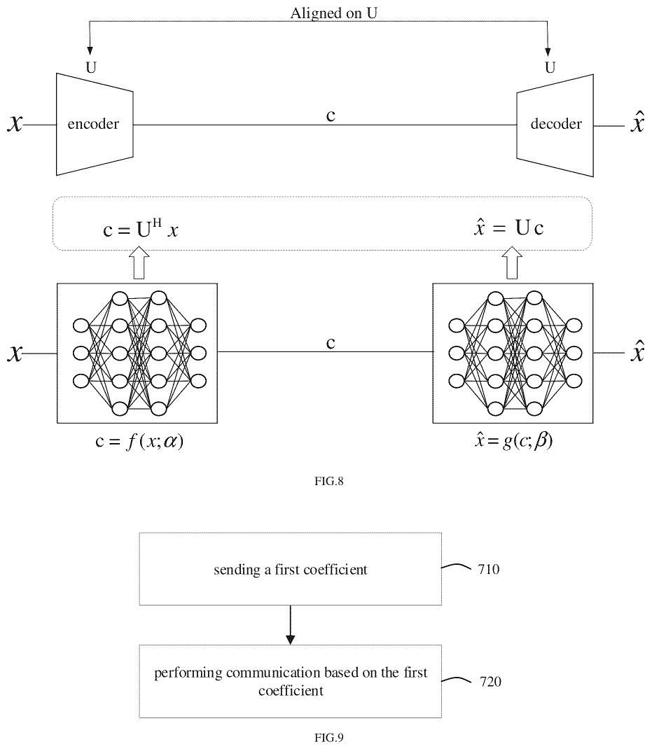

FIG. 9 is a flowchart of a communication method according to an embodiment of the present application.

710, sending a first coefficient.

The first coefficient is determined based on first data and a reference basis, and a dimension of the first coefficient is less than a dimension of the first data.

The first data includes monitoring data or measured data of the user equipment or the network device. Further, the first data is the monitoring data or measured data related to the AI models. The network device in this embodiment can be a BS. If the first data is the data sent by the UE to the BS over the uplink, the data is the monitoring or measured data of the UE. If the first data is the data sent by the BS to the UE over the downlink, the data is the monitoring or measured data of the BS.

One or multiple reference bases are predefined or configured. The reference basis is one of the predefined or configured multiple reference bases. For example, the reference basis can be configured by the BS for the UE. The reference basis can be an orthogonal basis, and any two columns of the reference basis are perfectly orthogonal to each other. One typical orthogonal basis is the DFT basis.

720, performing communication based on the first coefficient.

FIG. 10 is a flowchart of a communication method according to an embodiment of the present application. To protect raw data and save bandwidth, a group of the reference data samples are encoded or compressed to a lower dimensional space than their original space. The encoder or compressor can be linear or non-linear. A linear encoder can be realized with some standard basis such as Fourier basis, discrete cosine transform (DCT), wavelets. Alternatively, a linear encoder can be with some customized basis, and these bases may consist of a unitary matrix (orthonormal). A non-linear encoder can be realized with some DNNs.

In the embodiments given below, the UE projects a high-dimensional signal into a low-dimensional one (coefficients ĉ) by a transformation (orthonormal basis U). Reporting coefficients instead of raw data is efficient and conducive to privacy protection.

810, one or multiple reference bases are configured or predefined.

Coefficients of reference basis indicator (CRBI) are used to indicate coefficients with respect to a reference basis (e.g. orthogonal basis). Let {u₁, u₂, . . . , uᵣ} be an orthonormal set of vectors in the subspace Rn. This set forms a basis U for the subspace Rn. An element represented by basis U in the subspace Rn can be written as a finite weighted linear combination of elements of the basis. The coefficients of this weighed linear combination are referred to as components or coordinates (ĉ) of the vector with respect to the basis U.

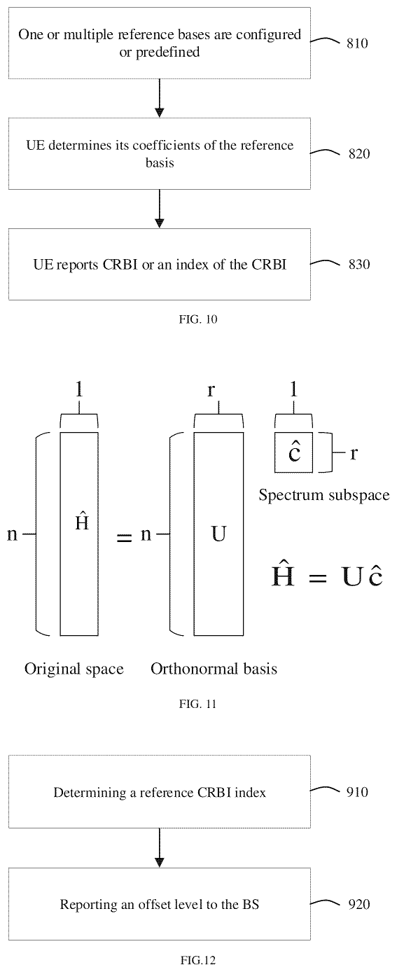

FIG. 11 is a schematic diagram of projecting a high-dimensional signal to a low-dimensional signal according to an embodiment of the present application. For example, Ĥ=Uĉ, where Ĥ is the original space of n×1, U is the orthogonal basis of n×r, and ĉ is the spectrum subspace of r×1. n is an integer greater than 1, and r<<n. H is the data to be reported by UE, e.g. sensing data, measured data, AI/machine learning (ML) data, channel data, environment data, etc. U is a reference basis as well as an orthogonal basis, and any two columns of U are perfectly orthogonal to each other. Embodiments of the present application can use columns as a basis, which can easily be applied to a basis matrix whose rows are the basis, simply U^{H}. One typical orthogonal basis is the discrete fourier transform (DFT) basis. ĉ is the CRBI, which is a reference coefficient.

Ĥ is denoted as an n-by-1 reference sample and U is n-by-r matrix. H can be represented by a weighted linear combination of each columns of U: Ĥ=Uĉ, where c is r-by-1 spectrum coefficients or weights. In the case of r<<n, ĉ is an equivalent low-dimensional space signal (vector) of Ĥ. The matrix U is unitary s.t. U^{H} U=I and ĉ=U^{H}Ĥ. Then, the matrix U^{H} is the encoder or compressor that compresses a high-dimensional (n-by-1) reference sample Ĥ into a low-dimensional (r-by-1) ĉ.

In one possible implementation scenario, multiple reference bases (U_{A}, U_{B}, U_{C}, . . . ) are configured or predefined. The BS configures which reference basis to use, e.g., U_{X}. The UE reports CRBI based on U_{X}. According to the formula Ĥ=Uĉ, the UE knows U and Ĥ, so the coefficients ĉ can be calculated.

In one possible implementation scenario, one reference matrix U is configured or predefined, and one or multiple pruning bases are indicated or predefined as the reference basis. The reference matrix Y is a matrix of size M rows and N columns. A pruning basis for the reference basis is a K-column of Y, such as the first K-column of Y, where K is configured and K≤N. Optionally, it can be specified which K columns of Y are selected as the pruning basis.

820, UE determines its coefficients of the reference basis.

A reference basis (U) is configured or predefined. The BS can configure one or more reference signals, and the UE can obtain raw data Ĥ by measuring the reference signal(s). Optionally, the reference signal(s) may also not be configured, and the UE can acquire the raw data Ĥ by sensing it. The UE determines its CRBI by ĉ=U^{H}Ĥ. U is a unitary matrix that satisfies the conjugate transpose of the matrix equal to the inverse of the matrix, i.e., U^{H} U=I, and I is the unit matrix.

The UE may obtain one or multiple reporting data from a single time slot. Based on an observation interval in time (or unrestricted), the UE shall derive CRBI values reported in uplink slot. Exemplarily, the UE reports CRBI values in uplink time slot n. The UE may obtain the corresponding one or multiple CRBI values by measuring the data in the configured time window n−5 to n−1. The UE can choose to report the multiple CRBI values or report the average/maximum/minimum of the multiple CRBI values.

830, UE reports CRBI or an index of the CRBI.

Exemplarily, the UE obtains P reporting data from the time window of n−5 to n−1, and P CRBI values corresponding to the P reporting data can be obtained by ĉ=U^{H}Ĥ. The UE can choose to report the average, maximum, or minimum of the P CRBI values. The reporting data includes monitoring data or measured data of the UE.

The UE can report the CRBI directly, or report the index corresponding to the CRBI. The BS can configure a physical uplink control channel (PUCCH) or a physical uplink shared channel (PUSCH) for the UE to report the CRBI. The CRBI reporting supports periodic, aperiodic, and semi-persistent.

In some possible application scenarios, the UE reports the index corresponding to the CRBI. In this scenario, one or multiple CRBI tables are predefined or configured. A reference basis can be associated with one CRBI table or with multiple CRBI tables. When a reference basis is associated with multiple CRBI tables, the BS indicates which CRBI table to use.

CRBI index of the CRBI table is reported by the UE. As shown in Table 1, 4 bits are used to indicate the CRBI index. Although the CRBI values in Table 1 are all denoted by the same {c₀, c₁, . . . , cᵣ}, each CRBI index corresponds to a different CRBI value. In some possible implementations, the value of r in {c₀, c₁, . . . , cᵣ} is different in different rows of a CRBI table, e.g., some are {c₀, c₁, . . . , c₅} and some are {c₀, c₁, . . . , c₆}.

TABLE 1

| CRBI index | CRBI |
|---|---|
| 0 | {c₀, c₁, . . . , cᵣ} |
| 1 | {c₀, c₁, . . . , cᵣ} |
| . . . | . . . |
| 15 | {c₀, c₁, . . . , cᵣ} |

In some possible implementations, one CRBI index may correspond to a CRBI range, and Table 1 should not be construed as a limitation of this application.

In the communication method provided in this embodiment, the UE can report its data information to the BS with minimum air interface overhead, and then the BS determines whether the data is significantly different from the training data, improving the efficiency of data reporting and protecting the privacy of the data.

FIG. 12 is a flowchart of a communication method according to an embodiment of the present application. In this embodiment, a differential CRBI index reporting can be used.

910, determining a reference CRBI index.

The reference CRBI index can be indicated by a BS, or it can be configured or predefined.

920, reporting an offset level to the BS.

The UE reports the offset level to the BS. According to the offset level and reference CRBI index, the BS knows the current data CRBI index. Exemplarily, the differential CRBI can be obtained by equation (1).

$$offset level = current data CRBI index - reference CRBI index \qquad ( 1 )$$

In the communication method provided in this embodiment, the UE can report its data information to the BS with minimum air interface overhead, and then the BS determines whether the data is significantly different from the training data, improving the efficiency of data reporting and protecting the privacy of the data.

In addition, the communication method provided in this application can also be applied to downlink (DL) transmission where the BS indicates the CRBI or CRBI index to the UE for indicating the data information at the BS side. Specific implementations can refer to the descriptions in FIG. 9 to FIG. 12 and will not be repeated in this application.

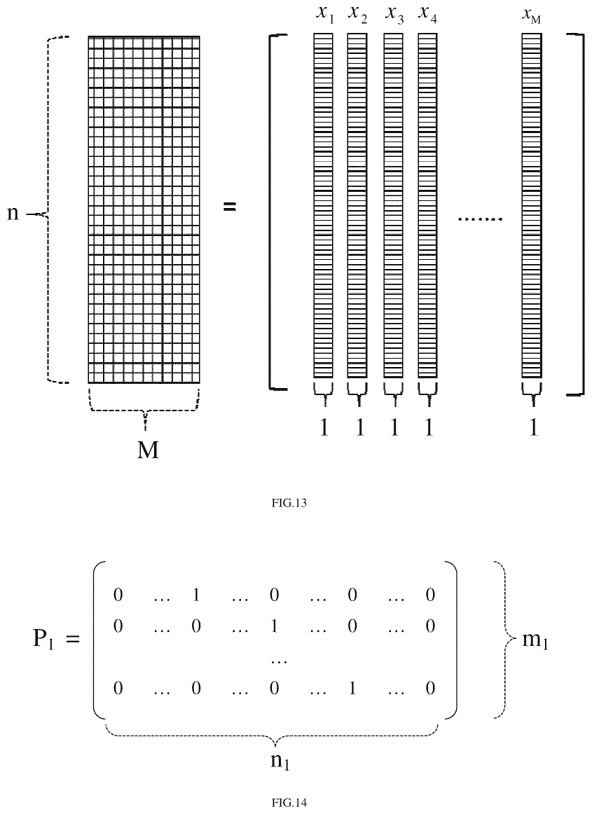

FIG. 13 is a schematic diagram of a matrix U being determined according to an embodiment of the present application.

Each column of the matrix U can be a standard basis such as Fourier basis, DCT basis, wavelet basis, and the like. Or the r columns of the matrix U can be built on the distribution of the group of the reference samples x. An example procedure to calculate the matrix U on the distribution of x₁, x₂, . . . maybe as follows:

Accumulating a sufficient amount (M) n-by-1 samples x₁, x₂, . . . x_{M}, and M<<n; Juxtaposing them into a n-by-M matrix [symbol] =[x₁ x₂ . . . x_{M}] and the order of data samples doesn't matter; Applying a rank-reduced singular value decomposition (SVD) on [symbol] : [symbol] =UΣV^{H}, where U is n-by-r unitary (orthonormal) matrix representing a commonality among all the M reference samples x.

Because a group of the reference data samples corresponds to one layer output, each group of the reference data samples has its own matrix U. The first group [symbol] =[x_{1,1} x_{1,2} . . . x_{1,M}_{₁}] has the matrix U₁ and compressed versions [symbol] ₁=[c_{1,1} c_{1,2} . . . c_{1,M}_{₁}], and the second group [symbol] ₂=[x_{2,1} x_{2,2} . . . x_{2,M}_{₂}] has the matrix U₂ compressed versions [c_{2,1} c_{2,2} . . . c_{2,M}_{₂}]

The communication system of the device receives the first matrix U₁ and the first group of reference samples (compressed) [symbol] ₁, and the second matrix U₂ and the second group of reference samples (compressed) [symbol] ₂.

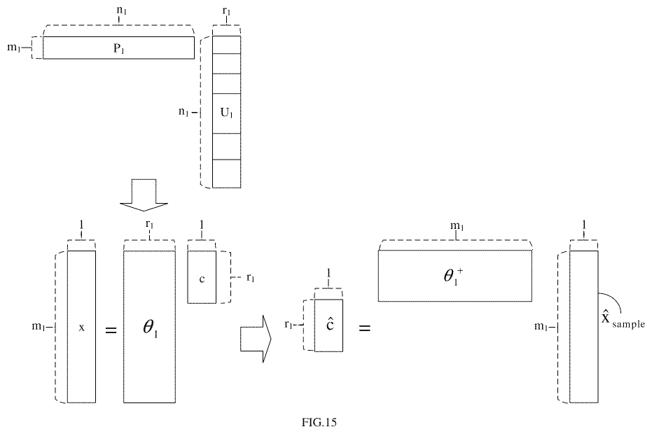

FIG. 14 is a schematic diagram of the first sampling matrix P₁ according to an embodiment of the present application.

The first matrix U₁ is n₁-by-r₁ and the second matrix U₂ is n₂-by-r₂. If n₁ and/or n₂ are very big numbers, the first sampling matrix P₁ can be applied to the first matrix U₁, and the second sampling matrix P₂ can be applied to the second matrix U₂. The first sampling matrix P₁ is m₁-by-n₁ (m₁<<n₁), and each row of which has only one “1” to indicate the position of x_{1,i} to be sampled. The second sampling matrix P₂ is m₂-by-n₂ (m₂<<n₂), and each row of which has only one “1” to indicate the position of x_{2,i} to be sampled. The first sampling matrix P₁ can “compress” the first matrix U₁ (n₁-by-r₁) into a m₁-by-r₁ θ₁ as θ₁=P₁U₁. Because θ₁ is much smaller than U₁ (because m₁<<n₁), θ₁ can be a better alternative to U₁. The second sampling matrix P₂ can “compress” the second matrix U₂ (n₂-by-r₂) into an m₂-by-r₂ θ₂ as θ₂=P₂U₂. Because θ₂ is much smaller than U₂ (because m₂<<n₂), θ₂ can be a better alternative to U₂.

FIG. 15 is a schematic diagram of a sampling matrix compression matrix U according to an embodiment of the present application.

In one possible implementation, the communication system of the device receives the first compact matrix θ₁, the first sampling matrix P₁, and the first group of reference samples (compressed) [symbol] ₁. The communication system of the device receives the second compact matrix θ₂, the second sampling matrix P₂, and the second group of reference samples (compressed) [symbol] ₂.

Alternatively, the communication system of the device receives the left inverse of the first compact matrix θ₁⁺, the first sampling matrix P₁, and the first group of reference samples (compressed) [symbol] ₁. The communication system of the device receives the inverse of the second compact matrix θ₂⁺, the second sampling matrix P₂, and the second group of reference samples (compressed) [symbol] ₂.

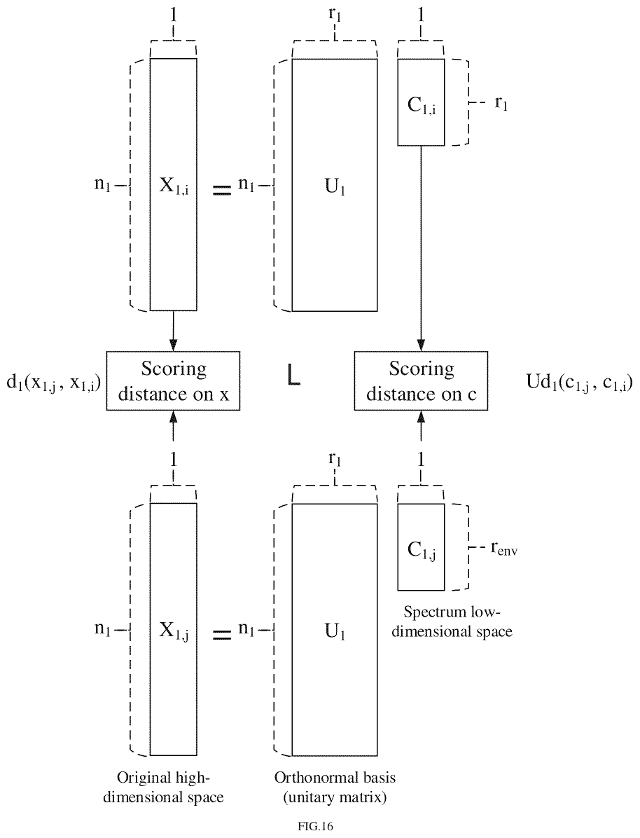

FIG. 16 is a schematic diagram of a scoring distance on the low spectrum space according to an embodiment of the present application.

The communication system of the device may receive the first scoring function d₁(c_{1,i}, c_{1,j}) that measures the distance between two samples, c_{1,i} and c_{1,j} of the first group. The communication system of the device may receive the second scoring function d₂(c_{2,i}, c_{2,j}) that measures the distance between two samples, c_{2,i} and c_{2,j} of the second group. The first scoring function d₁ and the second scoring function d₂ may be the same or different. The first scoring function d₁(,) and the second scoring function d₂(,) may be dot product, inner product, Euclidean distance, and so on. Or the first scoring function d₁(,) and the second scoring function d₂(,) may be DNN-based.

Alternatively, the communication system of the device may receive the first scoring function d₁( [symbol] ₁, [symbol] ₁′) that measures the distance between two distributions, [symbol] ₁ and [symbol] ₁′ of the first group. The communication system of the device may receive the second scoring function d₂( [symbol] ₂, [symbol] ₂′) that measures the distance between two distributions, [symbol] ₂ and [symbol] ₂′ of the second group. The first scoring function d₁ and the second scoring function d₂ may be the same or different. The first scoring function d₁(,) and the second scoring function d₂(,) maybe mutual information, Hilbert-Schmidt independence criterion (HSIC) metric, KL divergence, graph edit distance, Wasserstein distance, Jensen-Shannon divergence (JSD) distance, and so on. Or the first scoring function d₁(,) and the second scoring function d₂(,) may be DNN-based.

Due to generalization issues, the UE or the BS needs to detect its generalization performance and then switch to the proper AI models. For example, there are multiple AI models for multiple scenarios, including indoor urban, outdoor urban, rural, high speed train, etc. When the surrounding environment is changed, the BS or the UE needs to switch to another model. In prior art when the inference performance is getting worse, the UE or BS switches its AI model or falls back to non-AI mode. It is a kind of reactive solution. Embodiments of the present application provide multiple event-triggered designs that enable active switching of models.

BS configures multiple candidate AI/ML models to UEs, each model is configured a model index. Configuration signal could be radio resource control (RRC), medium access control-control element (MAC-CE) or downlink control information (DCI), and could be broadcast, multicast or unicast.

The BS configures an associated data anchor for each candidate AI/ML model. An anchor is a set of reference data, e.g. reference coefficients (ĉ). The reference data is reference coefficients of reference basis, and reference basis (U) is configured or pre-defined. A reference data (ĉ) can be a vector, e.g. a one-dimensional array, where the size of the vector is r, r is pre-defined or configured. The size of the set is K (cⱼ, j=1, 2, . . . K), where K is pre-defined or configured. Each of the N anchors includes K reference coefficients.

The association between a data anchor and a candidate AI/ML model can be determined implicitly or configured explicitly. Exemplarily, the association between the data anchor and the candidate AI/ML model is implicitly determined by making the anchor index have the same value as the model index, i.e. {model index k, anchor index k}. Exemplarily, the association between the data anchor and the candidate AI/ML model is explicitly configured, and the BS configures the data anchor j is associated with candidate model k, i.e. {model index k, anchor index j}.

The reference data (e.g. coefficient (ĉᵤₛₑᵣ)) is reference coefficients of reference basis (orthonormal basis U). During the information interaction between the UE and the BS, the UE can project the high-dimensional signal into the low-dimensional signal (coefficients ĉᵤₛₑᵣ) through a transformation (orthonormal basis U). The transformation equation is Ĥ=Uĉᵤₛₑᵣ, where Ĥ is the reporting data, U is the reference basis and ĉᵤₛₑᵣ is the reference coefficient. One column of U is one of the basis, meaning that any two columns of U are perfectly orthogonal to each other.

A reference basis (U) is configured or pre-defined. For example, the BS can configure a reference signal about the reference basis. Optionally, this reference signal may also be sensed by the UE. UE determines its coefficients of reference basis indicator (CRBI) by ĉᵤₛₑᵣ=U^{H}Ĥ. U is a unitary matrix that satisfies the conjugate transpose of the matrix equal to the inverse of the matrix, i.e., U^{H} U=I, I is the unit matrix.

UE calculates the difference between its data (e.g. coefficient (ĉᵤₛₑᵣ)) and the reference data cⱼ (j=1, 2, . . . K) in the anchor, where the calculation method or function can be indicated by BS or pre-defined. For example, the difference can be calculated by either of the equations (2), (3), and (4). d_{user,j} is the difference between the reporting data and the reference data ĉⱼ in the anchor. ĉᵤₛₑᵣ is the reporting data of the UE. ĉⱼ is the j^{th} reference data in the anchor.< > represents the inner product. ∥ ∥ represents the modulus length of a vector. f represents other custom functions. 1≤j≤K and 1≤i≤r.

$${d}_{user , j} = {\sum }_{i}^{r} {‖ {\hat{c}}_{user} ( i ) - {\hat{c}}_{j} ( i ) ‖}^{2} \qquad ( 2 )$$

$${d}_{user , j} = 〈 {\hat{c}}_{user} , {\hat{c}}_{j} 〉 \qquad ( 3 )$$

$${d}_{user , j} = f ( {\hat{c}}_{user} , {\hat{c}}_{j} ) \qquad ( 4 )$$

Equations (2)-(4) are only examples, and the UE calculates the difference between its data (e.g. coefficient (ĉᵤₛₑᵣ)) and the reference data cⱼ (j=1, 2, . . . K) in the anchor can also by means of dot product, Euclidean distance, or DNN-based algorithm, etc., and the above examples should not be construed as a limitation of the present application.

An anchor is a set of reference data and the UE calculates the difference between its data and the anchor according to a method that can be indicated by the BS or predefined, such as equation (4) or (5). d_{user,anchor} is the difference between the reporting data and the anchor. d_{user,anchor} can be the minimum value of the difference between the reporting data ĉᵤₛₑᵣ and the K reference data ĉ in the anchor, or it can be the average value of the difference between the reporting data ĉᵤₛₑᵣ and the K reference data ĉ in the anchor.

$${d}_{user , anchor} = {min}_{j = 1 , … , K} ( {d}_{user , j} ) \qquad ( 5 )$$

$${d}_{user , anchor} = {Avg}_{j = 1 , … , K} ( {d}_{user , j} ) \qquad ( 6 )$$

Alternatively, the difference between the reporting data and the anchor can also be obtained by mutual information, Hilbert-Schmidt independence criterion (HSIC) metric, Kullback-Leibler (KL) scatter, graphical edit distance, Wasserstein distance, Jensen-Shannon divergence (JSD) distance, DNN-based algorithms, etc.

For an AI/ML mode monitor, the BS configures the monitor reporting as event Triggered. One of multiple AI model monitoring events can be configured as event K1, event K2, event K3, event K4, etc.

FIG. 17 is a flowchart of a communication method according to an embodiment of the present application.

1510, sending a report indicating switching of an AI model or switching of a mode when an entry condition or a leaving condition of an event is fulfilled.

The present application defines events as follows: event K1: an operation of switching from an AI model to a non-AI model; event K2: an operation of switching from one AI/ML model (model 1) to another AI/ML model (model 2); event K3: an operation of switching from a non-AI mode to an AI mode; and event K4: an operation of switching from one AI/ML model (model 2) to another AI/ML model (model 1).

The method provided in the present application defines multiple events and entry and leaving conditions corresponding to the events, which enable active model or mode switching when the conditions are fulfilled.

1520, performing communication based on the report.

In event K1, the entry or leaving condition requires determining whether the difference value between the first data and the first anchor is greater than a threshold. The first anchor can be indicated by a BS, e.g., the first anchor is the data anchor of a UE's current AI/ML model. Alternatively, the first anchor is the closest data anchor to the UE's first data. The first data includes monitoring data or measured data of the UE. In a possible implementation, the first data includes any one or more of sensing data, measured data, channel data, neuron data of an AI model, and latent output data of the AI model.

Event K1 means the current or the best AI/ML model may be out of date, and the UE should be switched to the non-AI mode.

The entry condition of event K1 is considered to be satisfied when the condition K1-1 specified below is fulfilled.

$${Diff}_{11} - {Hys}_{11} > {Thresh}_{11} \qquad ( K1 - 1 )$$

Diff11 is the difference value between the first data and the first anchor. Hys11 is the hysteresis parameter for event K1, and pre-defined or configured by the BS. Thresh1 is the threshold parameter for event K1, and pre-defined or configured by the BS. Thresh11, Hys11 are expressed in the same unit as Diff11.

The leaving condition of the event K1 is considered to be satisfied when the condition K1-2 specified below is fulfilled.

$${Diff}_{11} + {Hys}_{12} < {Thresh}_{12} \qquad ( K 1 - 2 )$$

Hys12 is the hysteresis parameter for event K1, and pre-defined or configured by the BS. Thresh12 is the threshold parameter for event K1, and pre-defined or configured by the BS. The units of Hys12 and Thresh12 are the same as the unit of Diff11. Hys11 and Hys12 can be the same or different, e.g. they can be similar. Thresh11 and thresh12 can be the same or different, e.g. they can be similar.

The BS configures whether a parameter “reportOnLeave” is enabled or disabled. If disabled, no report is sent when the leaving condition is satisfied.

In addition, the BS also configures a parameter called “Time to Trigger”, which specifies a range of values to be used for the time to trigger a parameter, and relates to the time during which specific criteria for the event need to be met in order to trigger a report.

Another possible entry or leaving condition for K1 is that there is an additional offset.

The entry condition of event K1 is considered to be satisfied when the condition K1-3 specified below is fulfilled.

$${Diff}_{11} + {offset}_{11} + {Hys}_{11} > {Thresh}_{11} \qquad ( K 1 - 3 )$$

The leaving condition of the event K1 is considered to be satisfied when the condition K1-4 specified below is fulfilled.

$${Diff}_{11} + {offset}_{12} + {Hys}_{12} < {Thresh}_{12} \qquad ( K 1 - 4 )$$

The offset 11 and the offset 12 can be the same or different. The values of offset11 and offset12 could be positive or negative numbers.

In some possible implementations, the values of Hys11 or Hys12 can be set to 0 or be not pre-defined or configured.

The method provided by the present application defines an event K1 and entry and leaving conditions corresponding to the event K1, and active switching of modes can be realized when any of the conditions is fulfilled.

Event K2 means that the current AI/ML model (called as model 1) may be out of date, and the UE should be switched to another model (model 2).

In the event K2, the current model becomes worse than a Thresh21, and another model becomes better than a Thresh22. Being worse than the Thresh21 means that the second difference value between the first data and a second anchor is greater than the Thresh21. Being better than the Thresh22 means that a third difference value between the first data and a third anchor is smaller than the Thresh22. The second anchor is a data anchor associated with the first AI model (model 1), and the third anchor is a data anchor associated with the second AI model (model 2).

The entry condition of the event K2 is considered to be satisfied when the condition K2-1 specified below is fulfilled.

$${Diff}_{21} - {Hys}_{21} > {Thresh}_{21} and {Diff}_{22} + {Hys}_{22} < {Thresh}_{22} \qquad ( K 2 - 1 )$$

Diff21 is a difference between the first data and the second anchor, where the second anchor can be configured, e.g. a data anchor associated with model 1. Diff22 is a difference between the first data and the third anchor, where the third anchor can be configured, e.g. a data anchor associated with model 2. Hys21 and Hys22 are pre-defined or configured parameters corresponding to the event K2. Thresh21 is a pre-defined or configured threshold corresponding to the first AI model, and Thresh22 is a pre-defined or configured threshold corresponding to the second AI model. Thresh21 and Thresh22 can be configured to be the same or different.

The leaving condition of the event K2 is considered to be satisfied when the condition K2-2 or K2-3 specified below is fulfilled.

$${Diff}_{21} + {Hys}_{23} < {Thresh}_{23} \qquad ( K 2 - 2 )$$

$${Diff}_{22} - {Hys}_{24} > {Thresh}_{24} \qquad ( K 2 - 3 )$$

The condition K2-2 means that the first AI model is better than the threshold23. The condition K2-3 means that the second AI model is worse than the threshold24. One of the conditions K2-2 or K2-3 is satisfied and the UE leaves the event K2.

Hys23 and Hys24 are pre-defined or configured parameters corresponding to the event K2. Thresh23 is a pre-defined or configured threshold corresponding to the first AI model, and Thresh24 is a pre-defined or configured threshold corresponding to the second AI model. Hys21 and Hys23 can be the same or different, e.g. they can be similar. Hys22 and Hys24 can be the same or different, e.g. they can be similar. Thresh21 and Thresh23 can be the same or different, e.g. they can be similar. Thresh22 and Thresh24 can be the same or different, e.g. they can be similar.

The BS configures whether a parameter “reportOnLeave” is enabled or disabled. If disabled, no report is sent when the leaving condition is satisfied.

In addition, the BS also configures a parameter called “Time to Trigger”, which specifies a range of values to be used for the time to trigger a parameter, and relates to the time during which specific criteria for the event need to be met in order to trigger a report.

Another possible entry or leaving condition for K2 is that there is an additional offset.

The entry condition of the event K2 is considered to be satisfied when the condition K2-4 specified below is fulfilled.

$${Diff}_{21} + {offset}_{21} - {Hys}_{21} > Thres {h}_{21} and {Diff}_{22} + {offset}_{22} + {Hys}_{21} < {Thresh}_{22} \qquad ( K 2 - 4 )$$

The leaving condition of the event K2 is considered to be satisfied when the condition K2-5 or K2-6 specified below is fulfilled.

$${Diff}_{21} + {offset}_{23} + {Hys}_{23} < {Thresh}_{23} \qquad ( K 2 - 5 )$$

$${Diff}_{22} + {offset}_{24} - {Hys}_{24} > {Thresh}_{24} \qquad ( K 2 - 6 )$$

The offset 21 and the offset 23 can be the same or different, e.g. they can be similar. The offset 22 and the offset 24 can be the same or different, e.g. they can be similar. The values of offset21, offset 22, offset 23, and offset24 could be positive or negative numbers.

In some possible implementations, the values of Hys21, Hys22, Hys23 or Hys24 can be set to 0 or be not pre-defined or configured.

The method provided by the present application defines an event K2 and entry and leaving conditions corresponding to the event K2, and active switching of models can be realized when any of the conditions is fulfilled.

Event K3 means that an AI/ML model becomes better than a threshold, and the UE should be switched from a non-AI mode to an AI mode.

In the event K3, the fourth difference value between the first data and a fourth anchor is smaller than a threshold. The fourth anchor can be indicated by the BS, or the fourth anchor is the closest data anchor to the first data, i.e., the fourth anchor is the data anchor among the multiple anchors that differs least from the first data.

The entry condition of the event K3 is considered to be satisfied when the condition K3-1 specified below is fulfilled.

$${Diff}_{31} + {Hys}_{31} < {Thresh}_{31} \qquad ( K 3 - 1 )$$

Diff31 is the difference between the first data and the fourth anchor. Hys31 is a pre-defined or configured hysteresis parameter for the event K3. Thresh31 is a pre-defined or configured threshold corresponding to the event K3. Thresh31 and Hys31 are expressed in the same unit as Diff31.

When the entry condition of the event K3 is satisfied, the UE can report an index of the closest anchor.

The leaving condition of the event K3 is considered to be satisfied when the condition K3-2 specified below is fulfilled.

$${Diff}_{31} + {Hys}_{32} > {Thresh}_{32} \qquad ( K 3 - 2 )$$

Hys32 is a pre-defined or configured hysteresis parameter for the event K3. Thresh32 is a pre-defined or configured threshold corresponding to the event K3. Hys31 and Hys32 can be the same or different, e.g. they can be similar. Thresh31 and thresh32 can be the same or different, e.g. they can be similar.

The BS configures whether a parameter “reportOnLeave” is enabled or disabled. If disabled, no report is sent when the leaving condition is satisfied.

In addition, the BS also configures a parameter called “Time to Trigger”, which specifies a range of values to be used for the time to trigger a parameter, and relates to the time during which specific criteria for the event need to be met in order to trigger a report.

Another possible entry or leaving condition for K3 is that there is an additional offset.

The entry condition of the event K3 is considered to be satisfied when the condition K3-3 specified below is fulfilled.

$${Diff}_{31} + {offset}_{31} + {Hys}_{31} < {Thresh}_{31} \qquad ( K 3 - 3 )$$

The leaving condition of the event K3 is considered to be satisfied when the condition K3-4 specified below is fulfilled.

$${Diff}_{31} + {offset}_{32} - {Hys}_{32} > {Thresh}_{32} \qquad ( K 3 - 4 )$$

The offset 31 and the offset 32 can be the same or different. The values of offset31 and offset32 could be positive or negative numbers.

In some possible implementations, the values of Hys31 or Hys32 can be set to 0 or be not pre-defined or configured.

The method provided by the present application defines an event K3 and entry and leaving conditions corresponding to the event K3, and active switching of modes can be realized when any of the conditions is fulfilled.

In an event K4, another model (model 1) is better than the current model (model 2) and the UE should switch to model 1.

The entry condition of the event K4 is considered to be satisfied when the condition K4-1 specified below is fulfilled.

$${Diff}_{42} + {Hys}_{41} < {Diff}_{41} \qquad ( K 4 - 1 )$$

Diff41 is a difference between the first data and a fifth anchor, where the fifth anchor can be configured, e.g. a data anchor associated with model 2. Diff42 is a difference between the first data and a sixth anchor, where the sixth anchor can be configured, e.g. a data anchor associated with model 1. Hys41 is a pre-defined or configured parameter corresponding to the event K4.

The leaving condition of the event K4 is considered to be satisfied when the condition K4-2 specified below is fulfilled.

$${Diff}_{42} - {Hys}_{42} > {Diff}_{41} \qquad ( K 4 - 2 )$$

Hys42 is a pre-defined or configured parameter corresponding to the event K4. Hys41 and Hys42 can be the same or different, e.g. they can be similar.

The BS configures whether a parameter “reportOnLeave” is enabled or disabled. If disabled, no report is sent when the leaving condition is satisfied.

In addition, the BS also configures a parameter called “Time to Trigger”, which specifies a range of values to be used for the time to trigger a parameter, and relates to the time during which specific criteria for the event need to be met in order to trigger a report.

Another possible entry or leaving condition for K4 is that there is an additional offset.

The entry condition of the event K4 is considered to be satisfied when the condition K4-3 specified below is fulfilled.

$${Diff}_{42} + {offset}_{42} + {Hys}_{41} < {Diff}_{41} + {offset}_{41} \qquad ( K 4 - 3 )$$

The leaving condition of the event K4 is considered to be satisfied when the condition K4-4 specified below is fulfilled.

$${Diff}_{42} + {offset}_{42} - {Hys}_{42} > {Diff}_{41} + {offset}_{41} \qquad ( K 4 - 4 )$$

The offset 41 and the offset 42 can be the same or different. The values of offset41 and offset42 could be positive or negative numbers.

In some possible implementations, the value of Hys41 or Hys42 can be set to 0 or be not pre-defined or configured.

The method provided by the present application defines an event K4 and entry and leaving conditions corresponding to the event K4, and active switching of models can be realized when any of the conditions is fulfilled.

The above embodiments are examples of the UE actively performing model or mode switching, and the method of the BS actively performing model or mode switching is similar to the above embodiments, and the specific implementation can be found in the description of the above events K1 to K4, which will not be repeated in the present application.

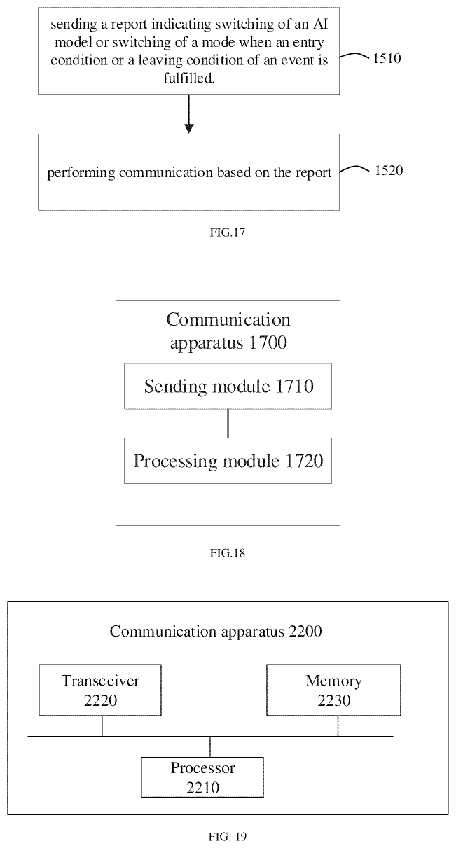

FIG. 18 is a schematic block diagram of a communication apparatus 1700 according to an embodiment of this application. The communication apparatus 1700 includes: a sending module 1710 configured to send a report indicating switching of an AI model or switching of a mode when an entry condition or a leaving condition of an event is fulfilled.

In a possible implementation, the event is an operation of switching from an AI mode to a non-AI mode, where the entry condition is determined by Diff11 and Thresh11, or the leaving condition is determined by Diff11 and Thresh12, where Diff11 is a first difference value, Thresh11 is a first threshold, Thresh12 is a second threshold, the first difference value is a difference value between first data and a first anchor, the first anchor includes one or multiple pieces of reference data, and the first threshold and the second threshold are pre-defined or configured thresholds corresponding to the event.

In a possible implementation, the entry condition is Diff11− Hys1>Thresh11, or the leaving condition is Diff1+Hys12<Thresh12.

In a possible implementation, the entry condition is Diff1+offset11−Hys11>Thresh11, or the leaving condition is Diff1+offset12+Hys12<Thresh12, where offset11 and offset12 are pre-defined or configured offsets.

In a possible implementation, Hys11 is a first hysteresis parameter, Hys12 is a second hysteresis parameter, and the first hysteresis parameter and the second hysteresis parameter are pre-defined or configured parameters corresponding to the event.

In a possible implementation, the event is an operation of switching from a first AI model to a second AI model, where the entry condition is determined by Diff21, Diff22, Thresh21 and Thresh22, or the leaving condition is determined by Diff21, Diff22, Thresh23 and Thresh24, where Diff21 is a second difference value, Diff22 is a third difference value, Thresh21 is a third threshold, Thresh22 is a fourth threshold, Thresh23 is a fifth threshold, Thresh24 is a sixth threshold, the second difference value is a difference value between first data and a second anchor, the second anchor is a data anchor associated with the first AI model, the third difference value is a difference value between the first data and a third anchor, the third anchor is a data anchor associated with the second AI model, the third threshold and the fifth threshold are pre-defined or configured thresholds corresponding to the first AI model, and the fourth threshold and the sixth threshold are pre-defined or configured thresholds corresponding to the second AI model.

In a possible implementation, the entry condition is Diff21−Hys21>Thresh21 and Diff22+Hys22<Thresh22, or the leaving condition is Diff21+Hys23<Thresh23 or Diff22−Hys24>Thresh24.

In a possible implementation, the entry condition is Diff21+offset21−Hys21>Thresh21 and Diff22+offset22+Hys22<Thresh22, and the leaving condition is Diff21+offset23+Hys23<Thresh23 or Diff22+offset24−Hys24>Thresh24, where offset21, offset22, offset23 and offset24 are pre-defined or configured offsets.

In a possible implementation, Hys21 is a third hysteresis parameter, Hys22 is a fourth hysteresis parameter, Hys23 is a fifth hysteresis parameter, Hys24 is a sixth hysteresis parameter, and the third hysteresis parameter, the fourth hysteresis parameter, the fifth hysteresis parameter and the sixth hysteresis parameter are pre-defined or configured parameters corresponding to the event.

In a possible implementation, the event is an operation of switching from a non-AI mode to an AI mode, where the entry condition is determined by Diff31 and Thresh31, or the leaving condition is determined by Diff31 and Thresh32, where Diff31 is a fourth difference value, Thresh31 is a seventh threshold, Thresh32 is an eighth threshold, the fourth difference value is a difference value between first data and a fourth anchor, the fourth anchor includes one or multiple pieces of reference data, and the seventh threshold and the eighth threshold are pre-defined or configured thresholds corresponding to the event.

In a possible implementation, the entry condition is Diff31+Hys31<Thresh31, or the leaving condition is Diff31−Hys32>Thresh32.

In a possible implementation, the entry condition is Diff31+offset31+Hys31<Thresh31, and the leaving condition is Diff31+offset32−Hys32>Thresh32, where offset31 and offset32 are pre-defined or configured offsets.

In a possible implementation, Hys31 is a seventh hysteresis parameter, Hys32 is an eighth hysteresis parameter, and the seventh hysteresis parameter and the eighth hysteresis parameter are pre-defined or configured parameters corresponding to the event.

In a possible implementation, the event is an operation of switching from a third AI model to a fourth AI model, where the entry condition is determined by Diff41 and Diff42, or the leaving condition is determined by Diff41 and Diff42, Diff41 is a fifth difference value, Diff42 is a sixth difference value, the fifth difference value is a difference value between first data and a fifth anchor, the fifth anchor is a data anchor associated with the third AI model, the sixth difference value is a difference value between the first data and a sixth anchor, and the sixth anchor is a data anchor associated with the fourth AI model.

In a possible implementation, the entry condition is Diff42+Hys41<Diff41, and the leaving condition is Diff42−Hys42>Diff41.

In a possible implementation, the entry condition is Diff42+offset42+Hys41<Diff41+offset41, and the leaving condition is Diff42+offset42−Hys42>Diff41+offset41, where offset41 and offset42 are pre-defined or configured offsets.

In a possible implementation, Hys41 is a ninth hysteresis parameter, Hys42 is a tenth hysteresis parameter, and the ninth hysteresis parameter and the tenth hysteresis parameter are pre-defined or configured parameters corresponding to the event.

In a possible implementation, the first data includes monitoring data or measured data of a user equipment or a network device.

In a possible implementation, the first data includes monitoring data or measured data related to an AI model of the user equipment or the network device.

In a possible implementation, the first data includes any one or more of sensing data, measured data, channel data, neuron data of an AI model, and latent output data of the AI model.

In a possible implementation, the apparatus further includes a processing module 1720 configured to perform communication based on the report.

In a possible implementation, the apparatus is located on a user equipment or a network device.

As shown in FIG. 19, a communication apparatus 2200 may include a processor 2210 and a transceiver 2220. Optionally, the communication apparatus 2200 may further include a memory 2230. The memory 2230 may be configured to store indication information, or may be configured to store code, instructions, and the like that is to be executed by the processor 2210.

The memory 2230 may include a random memory, a flash memory, a read-only memory, a programmable read-only memory, a non-volatile memory, a register, or the like. The processor 2210 may be a central processing unit (CPU).

For other functions and operations of the communication apparatus 2200, refer to processes of the method embodiments from FIG. 5 to FIG. 16, which are not described again herein to avoid repetition.

An embodiment of the present application further provides a computer storage medium, and the computer storage medium may store a program instruction for performing the steps in the foregoing methods.

Optionally, the storage medium maybe specifically the memory 2230.

An embodiment of the present application further provides a computer program product. The computer program product includes computer program code. When the computer program code runs on a computer, the computer is enabled to perform the steps in the foregoing methods.

Optionally, all or a part of computer program code can be stored in on a first storage medium. The first storage medium can be packaged together with the processor or separately with the processor.

An embodiment of the present application further provides a chip system, where the chip system includes an input/output interface, at least one processor, at least one memory, and a bus. The at least one memory is configured to store instructions, and the at least one processor is configured to invoke the instructions of the at least one memory to perform operations in the methods in the foregoing embodiments.

A person of ordinary skill in the art may understand that all or some of the processes of the methods in the embodiments may be implemented by a computer program instructing related hardware. The program maybe stored in a computer-readable storage medium. When the program runs, the processes of the methods in the embodiments are performed. The foregoing storage medium may include: a magnetic disk, an optical disc, a read-only memory (ROM), or a random-access memory (RAM).

In the several embodiments provided in the present application, it should be understood that the disclosed system, apparatus, and method may be implemented in other manners. For example, the described apparatus embodiment is merely exemplary. For example, the unit division is merely logical function division and maybe other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention maybe integrated into one processing unit, or each of the units may exist alone physically, or two or more units are integrated into one unit.

The foregoing are merely exemplary embodiments of the present invention. A person skilled in the art may make various modifications and variations to the present invention without departing from and scope of the present invention.

1. A method, comprising:
sending a report indicating an event when an entry condition or a leaving condition of the event is fulfilled, wherein the event is one of an operation of switching from an artificial intelligence (AI) mode to a non-AI mode, an operation of switching from a first AI model to a second AI model, or an operation of switching from the non-AI mode to the AI mode.

2. The method according to claim 1,
wherein the event is the operation of switching from the AT mode to the non-AI mode,
wherein the entry condition is determined by Diff11 and Thresh11, or the leaving condition is determined by Diff11 and Thresh12, and
wherein Diff11 is a first difference value, Thresh1 is a first threshold, Thresh12 is a second threshold, the first difference value is a difference value between first data and a first anchor, the first anchor comprises one or multiple pieces of reference data, and the first threshold and the second threshold are pre-defined or configured thresholds corresponding to the event.

3. The method according to claim 2, wherein the entry condition is Diff11−Hys11>Thresh11, or the leaving condition is Diff11+Hys12<Thresh12.

4. The method according to claim 3, wherein Hys11 is a first hysteresis parameter, Hys12 is a second hysteresis parameter, and the first hysteresis parameter and the second hysteresis parameter are pre-defined or configured parameters corresponding to the event.

5. The method according to claim 2,
wherein the entry condition is Diff11+offset11−Hys11>Thresh11, or the leaving condition is Diff11+offset12+Hys12<Thresh12, and
wherein offset11 and offset12 are pre-defined or configured offsets.

6. The method according to claim 2, wherein the first data comprises any one or more of sensing data, measured data, channel data, neuron data of the AI model, or latent output data of the AI model.

7. The method according to claim 1,
wherein the event is the operation of switching from the first AI model to the second AI model,
wherein the entry condition is determined by Diff21, Diff22, Thresh21 and Thresh22, or the leaving condition is determined by Diff21, Diff22, Thresh23 and Thresh24, and
wherein Diff21 is a second difference value, Diff22 is a third difference value, Thresh21 is a third threshold, Thresh22 is a fourth threshold, Thresh23 is a fifth threshold, Thresh24 is a sixth threshold, the second difference value is a difference value between first data and a second anchor, the second anchor is a data anchor associated with the first AI model, the third difference value is a difference value between the first data and a third anchor, the third anchor is a data anchor associated with the second AI model, the third threshold and the fifth threshold are pre-defined or configured thresholds corresponding to the first AI model, and the fourth threshold and the sixth threshold are pre-defined or configured thresholds corresponding to the second AI model.

8. A communication apparatus, comprising:
at least one processor coupled with a memory storing instructions, when the at least one processor executes the instructions, cause the communication apparatus to:
send a report indicating an event when an entry condition or a leaving condition of the event is fulfilled, wherein the event is one of an operation of switching from an artificial intelligence (AI) mode to a non-AI mode, an operation of switching from a first AI model to a second AI model, or an operation of switching from the non-AI mode to the AI mode.

9. The communication apparatus according to claim 8,
wherein the event is an operation of switching from the AI mode to the non-AI mode,
wherein the entry condition is determined by Diff11 and Thresh11, or the leaving condition is determined by Diff11 and Thresh12, and
wherein Diff11 is a first difference value, Thresh1 is a first threshold, Thresh12 is a second threshold, the first difference value is a difference value between first data and a first anchor, the first anchor comprises one or multiple pieces of reference data, and the first threshold and the second threshold are pre-defined or configured thresholds corresponding to the event.

10. The communication apparatus according to claim 9, wherein the entry condition is Diff11−Hys11>Thresh11, or the leaving condition is Diff1+Hys12<Thresh12.

11. The communication apparatus according to claim 10, wherein Hys11 is a first hysteresis parameter, Hys12 is a second hysteresis parameter, and the first hysteresis parameter and the second hysteresis parameter are pre-defined or configured parameters corresponding to the event.

12. The communication apparatus according to claim 9,
wherein the entry condition is Diff1+offset11−Hys11>Thresh11, or the leaving condition is Diff1+offset12+Hys12<Thresh12, and
wherein offset11 and offset12 are pre-defined or configured offsets.

13. The communication apparatus according to claim 9, wherein the first data comprises any one or more of sensing data, measured data, channel data, neuron data of the AI model, or latent output data of the AI model.

14. The communication apparatus according to claim 8,
wherein the event is the operation of switching from the first AI model to the second AI model,
wherein the entry condition is determined by Diff21, Diff22, Thresh21 and Thresh22, or the leaving condition is determined by Diff21, Diff22, Thresh23 and Thresh24, and
wherein Diff21 is a second difference value, Diff22 is a third difference value, Thresh21 is a third threshold, Thresh22 is a fourth threshold, Thresh23 is a fifth threshold, Thresh24 is a sixth threshold, the second difference value is a difference value between first data and a second anchor, the second anchor is a data anchor associated with the first AI model, the third difference value is a difference value between the first data and a third anchor, the third anchor is a data anchor associated with the second AI model, the third threshold and the fifth threshold are pre-defined or configured thresholds corresponding to the first AI model, and the fourth threshold and the sixth threshold are pre-defined or configured thresholds corresponding to the second AI model.

15. A non-transitory computer-readable storage medium storing instructions, and when the instructions run on at least one processor, the at least one processor is enabled to:
send a report indicating an event when an entry condition or a leaving condition of the event is fulfilled, wherein the event is one of an operation of switching from an artificial intelligence (AI) mode to a non-AI mode, an operation of switching from a first AI model to a second AI model, or an operation of switching from the non-AI mode to the AI mode.

16. The non-transitory computer-readable storage medium according to claim 15,
wherein the event is an operation of switching from the AI mode to the non-AI mode,
wherein the entry condition is determined by Diff11 and Thresh11, or the leaving condition is determined by Diff11 and Thresh12, and
wherein Diff11 is a first difference value, Thresh1 is a first threshold, Thresh12 is a second threshold, the first difference value is a difference value between first data and a first anchor, the first anchor comprises one or multiple pieces of reference data, and the first threshold and the second threshold are pre-defined or configured thresholds corresponding to the event.

17. The non-transitory computer-readable storage medium according to claim 16, wherein the entry condition is Diff11−Hys11>Thresh11, or the leaving condition is Diff11+Hys12<Thresh12.

18. The non-transitory computer-readable storage medium according to claim 17, wherein Hys11 is a first hysteresis parameter, Hys12 is a second hysteresis parameter, and the first hysteresis parameter and the second hysteresis parameter are pre-defined or configured parameters corresponding to the event.

19. The non-transitory computer-readable storage medium according to claim 16,
wherein the entry condition is Diff11+offset11−Hys11>Thresh11, or the leaving condition is Diff11+offset12+Hys12<Thresh12, and
wherein offset11 and offset12 are pre-defined or configured offsets.

20. The non-transitory computer-readable storage medium according to claim 15,
wherein the event is the operation of switching from the first AI model to the second AI model,
wherein the entry condition is determined by Diff21, Diff22, Thresh21 and Thresh22, or the leaving condition is determined by Diff21, Diff22, Thresh23 and Thresh24, and
wherein Diff21 is a second difference value, Diff22 is a third difference value, Thresh21 is a third threshold, Thresh22 is a fourth threshold, Thresh23 is a fifth threshold, Thresh24 is a sixth threshold, the second difference value is a difference value between first data and a second anchor, the second anchor is a data anchor associated with the first AI model, the third difference value is a difference value between the first data and a third anchor, the third anchor is a data anchor associated with the second AI model, the third threshold and the fifth threshold are pre-defined or configured thresholds corresponding to the first AI model, and the fourth threshold and the sixth threshold are pre-defined or configured thresholds corresponding to the second AI model.
